(19) United States
(12) Patent Application Publication
(10) Pub. No.: US 2026/0058391 A1
(43) Pub. Date: Feb. 26, 2026

(54) MULTI-PURPOSE CONDUCTIVE PIECE AND SOCKET FOR USE WITH A VARIETY OF PLUGS

(71) Applicant: Top Electric (Tianjin) Co., Ltd., Tianjin (CN)

(72) Inventors: Haiqing LIN, Tianjin (CN); Qiang YU, Tianjin (CN); Jingwei LI, Tianjin (CN); Chunqi LI, Tianjin (CN)

(73) Assignee: Top Electric (Tianjin) Co., Ltd., Tianjin (CN)

(21) Appl. No.: 19/373,316

(22) Filed: Oct. 29, 2025

Related U.S. Application Data
(63) Continuation of application No. PCT/CN2024/089095, filed on Apr. 22, 2024.

(30) Foreign Application Priority Data
Apr. 29, 2023 (CN) 202310486815.4

(51) Int. Cl. H01R 13/11; H01R 27/00; H01R 105/00

(52) U.S. Cl. CPC H01R 13/11; H01R 27/00; H01R 2105/00

(57) ABSTRACT

The present application provides a multi-purpose conductive piece and a socket for use with a variety of plugs and relates to a technical field of socket. A multi-purpose conductive piece includes a base connection portion and a transverse head-bent sheet portion, a bent upright sheet portion, a longitudinal head-bent sheet portion, and a longitudinal upright sheet portion, wherein the bent upright sheet portion includes a longitudinal upright segment and a transverse upright segment, clearances exist between the longitudinal upright segment and the transverse head-bent sheet portion and between the transverse upright segment and the longitudinal upright sheet portion, the longitudinal head-bent sheet portion and the longitudinal upright sheet portion are capable of being electrically connected to, through a surface contact, an inserted longitudinal prong. The present application enhances the reliability of the electrical connection and extends the service life of the socket.

### CROSS-REFERENCE TO RELATED APPLICATIONS

This application is a continuation of International Application No. PCT/CN2024/089095, filed on April 22, 2024, which claims priority to Chinese Patent Application No. 202310486815.4, filed on April 29, 2023, both of which are hereby incorporated by reference in their entireties.

### FIELD

The disclosure relates to a technical field of socket, and in particular to a multi-purpose conductive piece and a socket for use with a variety of plugs.

### BACKGROUND

A conductive piece is a critical conductive component within a socket, which forms a plug-in electrical connection with a plug prong of a plug, thereby enabling an electrical connection between a plug prong and a conductive wire or copper busbar within the socket.

The plug for use with the national standard C13 socket (also known as IEC60320 C13, 10A, abbreviated as C13 socket) and the national standard C19 socket (also known as IEC60320 C19, 16A, abbreviated as C19 socket) have different prong structures. A prong of the plug cooperating with the C13 socket has a vertical line-shaped structure, while a prong of the plug cooperating with the C19 socket has a transverse line-shaped structure. Consequently, conductive pieces for use therewith have different structures.

In the prior art, to improve versatility, those skilled in the art have conceived a conductive piece structure for both C13 and C19 sockets. The versatility of this conductive piece structure has been improved, but other properties have deteriorated.

The applicant has found at least the following problems in the prior art.

1. In the existing conductive piece structure, the conductive piece and the plug prong are connected via linear contact. This connection has a small contact area, making it prone to disconnection and resulting in an unreliable electrical connection. Additionally, initial insertion and removal require considerable force, and the plug prong is susceptible to wear after a period of use, leading to a shorter service life.

2. The existing conductive piece structure uses three conductive copper pieces. The gap formed between them is adapted to the prongs of two types of plugs. However, a prong of the plug cooperating with the C19 socket is perpendicular to a prong of the plug cooperating with the C13 socket. Consequently, when the prong of one type of plug is frequently inserted into the gap between the three copper conductive pieces, the distance between the contacted copper pieces is widened. As a result, when the prong of the other type of plug is subsequently inserted, the contact is not tight, leading to an unreliable electrical connection.

In summary, the prior art has the problems of unreliable electrical connections, initial difficulty in insertion and removal, and the tendency of the plug prong to wear out after a period of use, leading to a shorter service life.

### SUMMARY

The present application provides a multi-purpose conductive piece and a socket for use with a variety of plugs, which solve the problems of the prior art in respect to unreliable electrical connections, initial difficulty in insertion and removal, and the tendency of the plug prong to wear out after a period of use, leading to a shorter service life.

The present application provides the following technical solutions. A multi-purpose conductive piece provided by the present application includes a base connection portion configured to form an electrical connection with a conducting wire and a transverse head-bent sheet portion, a bent upright sheet portion, a longitudinal head-bent sheet portion, and a longitudinal upright sheet portion fixedly connected to the base connection portion, wherein the transverse head-bent sheet portion and the bent upright sheet portion are capable of being electrically connected to, through a surface contact, an inserted transverse prong, the bent upright sheet portion includes a longitudinal upright segment and a transverse upright segment, clearances exist between the longitudinal upright segment and the transverse head-bent sheet portion and between the transverse upright segment and the longitudinal upright sheet portion, a gap formed between the transverse upright segment and the transverse head-bent sheet portion forms an insertion port for the transverse prong, the longitudinal head-bent sheet portion and the longitudinal upright sheet portion are capable of being electrically connected to, through a surface contact, an inserted longitudinal prong, and a gap between the longitudinal head-bent sheet portion and the longitudinal upright sheet portion forms an insertion port for the longitudinal prong.

Preferably or optionally, a surface of the transverse head-bent sheet portion, which is in proximity to the transverse upright segment naturally includes a first curved surface, a transition plane (transition may also be written as transiting), and a second curved surface sequentially and continuously distributed from top to bottom, wherein a curvature of the first curved surface is greater than that of the second curved surface, and the transition plane makes surface contact with an outer wall of the transverse prong after the transverse prong is inserted between the transverse head-bent sheet portion and the bent upright sheet portion.

Preferably or optionally, a surface of the longitudinal head-bent sheet portion, which is in proximity to the longitudinal upright sheet portion naturally includes an upper curved surface, a connection plane, and a lower curved surface sequentially and continuously distributed from top to bottom, wherein a curvature of the upper curved surface is greater than that of the lower curved surface, and the connection plane makes surface contact with an outer wall of the longitudinal prong after the longitudinal prong is inserted between the longitudinal head-bent sheet portion and the longitudinal upright sheet portion.

Preferably or optionally, the transverse prong is a prong of a C20 plug that is compliant with national standards, and the longitudinal prong is a prong of a C14 plug that is compliant with national standards.

Preferably or optionally, a stamped reinforcement rib is provided on the transverse head-bent sheet portion and the longitudinal head-bent sheet portion.

Preferably or optionally, the base connection portion, the transverse head-bent sheet portion, the bent upright sheet portion, the longitudinal head-bent sheet portion, and the longitudinal upright sheet portion are integrally formed as a one-piece structure.

Preferably or optionally, the longitudinal upright segment and the transverse upright segment are integrally formed as a one-piece structure, and an angle between the two is a right angle.

Preferably or optionally, the base connection portion is configured to form the electrical connection with the conducting wire by plugging, welding, wrapping, or using an intermediate conductor.

Preferably or optionally, the base connection portion is configured to form an electrical connection with a busbar (plate) (e.g., a conductive copper busbar, as an equivalent alternative to the conductive wire).

A multi-purpose conductive piece provided by an embodiment of the present application includes a base connection portion and a transverse head-bent sheet portion, a bent upright sheet portion, a longitudinal head-bent sheet portion, and a longitudinal upright sheet portion fixedly connected to the base connection portion, wherein the base connection portion is configured to form an electrical connection with a conducting wire or a conductive busbar, the transverse head-bent sheet portion and the bent upright sheet portion are capable of being electrically connected to, through a surface contact, an inserted transverse prong, the bent upright sheet portion includes a transverse upright segment, a clearance exists between the transverse upright segment and the longitudinal upright sheet portion, a gap formed between the transverse upright segment and the transverse head-bent sheet portion forms an insertion port for the transverse prong, the longitudinal head-bent sheet portion and the longitudinal upright sheet portion are capable of being electrically connected to, through a surface contact, the inserted longitudinal prong, and a gap between the longitudinal head-bent sheet portion and the longitudinal upright sheet portion forms an insertion port for the longitudinal prong.

A socket for use with a variety of plugs provided by an embodiment of the present application includes at least one socket unit, each of which is adapted to one of the plurality of plugs, wherein the socket unit includes a housing and at least two multi-purpose conductive pieces according to any one technical solution of the present application disposed within the housing (each socket unit includes three multi-purpose conductive piece), and the housing is provided with insertion holes, each of which corresponds to one of the multi-purpose conductive pieces.

Preferably or optionally, the housing includes an upper case and a lower case, wherein the insertion holes are provided in the upper case, which is selected from one of three types: a first type of upper case with T-shaped insertion holes, a second type of upper case with transverse line-shaped insertion holes, and a third type of upper case with longitudinal line-shaped insertion holes, each type of upper case capable of being adapted to the lower case with a same structure.

Preferably or optionally, an angle between an upper surface of the housing and each of the longitudinal upright sheet portion, the longitudinal upright segment, and the transverse upright segment is a right angle.

Preferably or optionally, the two multi-purpose conductive pieces are arranged symmetrically to each other, the bent upright sheet portions of the two symmetrically arranged multi-purpose conductive pieces are arranged in proximity to each other, and the longitudinal upright sheet portions of the two symmetrically arranged multi-purpose conductive pieces are arranged in proximity to each other.

The technical solutions provided by any one of the embodiments of the present application achieve at least the following technical effects. In the present application, the transverse head-bent sheet portion and the bent upright sheet portion are capable of being electrically connected to, through a surface contact, an inserted transverse prong, and the longitudinal head-bent sheet portion and the longitudinal upright sheet portion are capable of being electrically connected to, through a surface contact, an inserted longitudinal prong. Compared to the linear contact connection in the prior art, the surface contact connection not only has a larger contact area and higher electrical connection reliability, but also subjects the plug prong to relatively lower friction and pressure. This results in smoother insertion and removal, reduced wear, and consequently an extended service life. Furthermore, the bent upright sheet portion includes a longitudinal upright segment and a transverse upright segment, clearances exist between the longitudinal upright segment and the transverse head-bent sheet portion and between the transverse upright segment and the longitudinal upright sheet portion, a gap formed between the transverse upright segment and the transverse head-bent sheet portion forms an insertion port for the transverse prong, and a gap between the longitudinal head-bent sheet portion and the longitudinal upright sheet portion forms an insertion port for the longitudinal prong. Thus, the insertion port for the transverse prong and the insertion port for the longitudinal prong are spaced apart. As a result, the insertion and removal operations of the transverse prong and the longitudinal prong do not interfere with each other, and the insertion and removal of either prong will not alter the shape or dimensions of the insertion port for the other prong, thereby enhancing reliability. The present application solves the problems of the prior art in respect to unreliable electrical connections, initial difficulty in insertion and removal, and the tendency of the plug prong to wear out after a period of use, leading to a shorter service life.

### BRIEF DESCRIPTION OF THE DRAWINGS

The technical effects of the present application will be better understood by those skilled in the art with reference to the following drawings, wherein:

FIG. 1 is a schematic view of a three-dimensional structure of a multi-purpose conductive piece provided by an embodiment of the present application;

FIG. 2 is a perspective schematic view showing the distribution positions of three multi-purpose conductive pieces (the housing and wires are omitted) provided by an embodiment of the present application used in a socket for use with a variety of plugs;

FIG. 3 is a perspective schematic view of a front face (a cooperating face with a plug) of a socket for use with a variety of plugs provided by an embodiment of the present application;

FIG. 4 is a plan schematic view of a socket for use with a variety of plugs provided by an embodiment of the present application;

FIG. 5 is a sectional view of the socket shown in FIG. 4;

FIG. 6 is another sectional view of the socket shown in FIG. 4;

FIG. 7 is a plan schematic view of another type of socket provided by an embodiment of the present application;

FIG. 8 is a plan schematic view of yet another type of socket provided by an embodiment of the present application;

### REFERENCE NUMBERS IN THE DRAWINGS:

1. multi-purpose conductive piece; 11. base connection portion; 110. wiring portion; 12. transverse head-bent sheet portion; 121. first curved surface; 122. transition plane; 123. second curved surface; 13. bent upright sheet portion; 131. longitudinal upright segment; 132. transverse upright segment; 14. longitudinal head-bent sheet portion; 141. upper curved surface; 142. connection plane; 143. lower curved surface; 15. longitudinal upright sheet portion; 16. clearance; 17. housing; 171. upper case; 172. lower case; 18. reinforcement rib.

### DETAILED DESCRIPTION

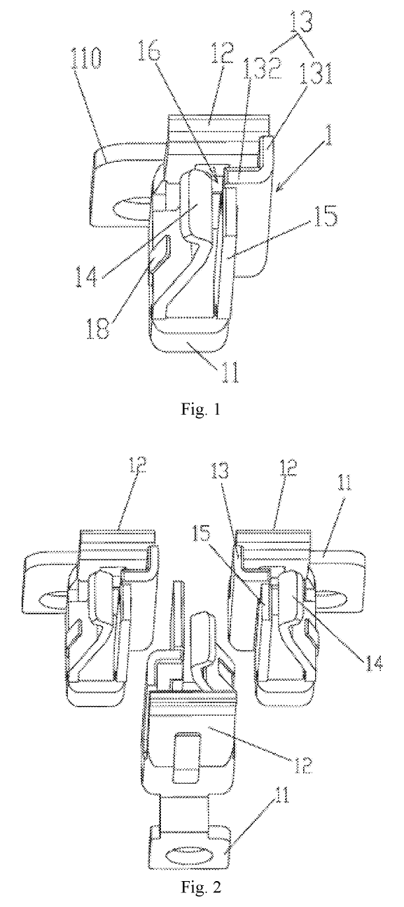

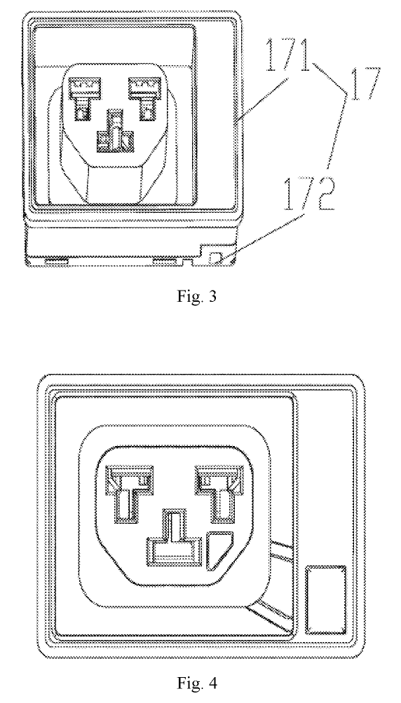

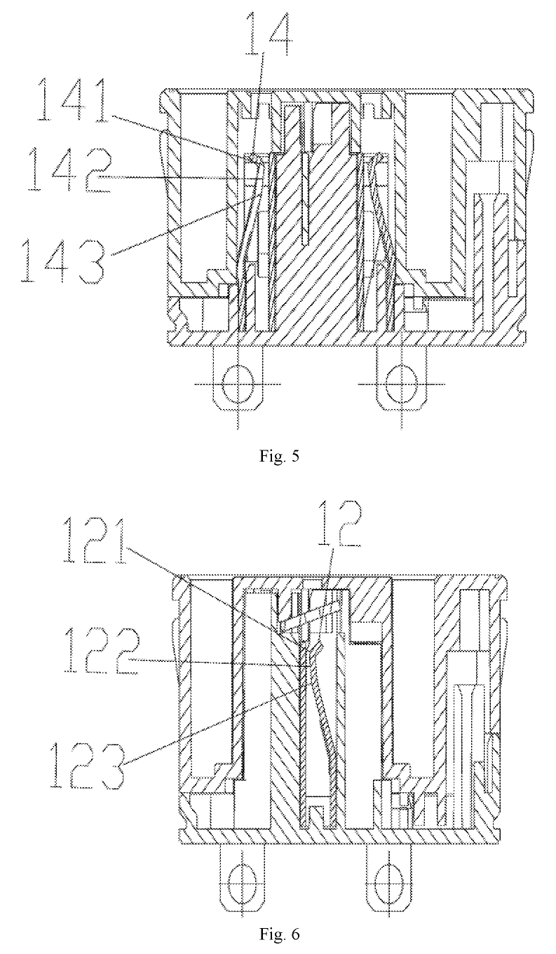

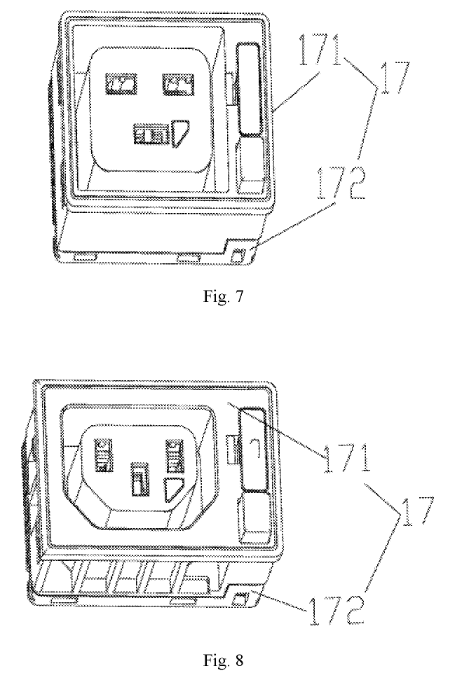

Below, the preferred implementations provided by the embodiments of the present application and numerous optional implementations will be described in detail with reference to FIGS. 1 to 8 above;

The terms “transverse” and “longitudinal” mentioned in the embodiments of the present application are assigned merely for the purpose of describing two components in a perpendicular positional relationship rather than restricting the spatial positions of the socket and components thereof. Similarly, the terms “first” and “second” are assigned merely for the purpose of distinguishing different components rather than posing a limit to the quantity.

As shown in FIGS. 1 to 8, the multi-purpose conductive piece 1 provided by the present application includes a base connection portion 11 configured to form an electrical connection with a conductive wire and a transverse head-bent sheet portion 12, a bent upright sheet portion 13, a longitudinal head-bent sheet portion 14, and a longitudinal upright sheet portion 15 fixedly connected to the base connection portion 11, the base connection portion 11 preferably includes a wiring portion 110 that extends transversely or longitudinally in a curved manner, and a conductive wire connection hole is provided in the wiring portion 110; the transverse head-bent sheet portion 12 and the bent upright sheet portion 13 are capable of being electrically connected to, through a surface contact, an inserted transverse prong. The bent upright sheet portion 13 includes a longitudinal upright segment 131 and a transverse upright segment 132, clearances 16 exist between the longitudinal upright segment 131 and the transverse head-bent sheet portion 12 and between the transverse upright segment 132 and the longitudinal upright sheet portion 15, and a gap formed between the transverse upright segment 132 and the transverse head-bent sheet portion 12 forms an insertion port for the transverse prong; the longitudinal head-bent sheet portion 14 and the longitudinal upright sheet portion 15 are capable of being electrically connected to, through a surface contact, an inserted longitudinal prong, and a gap between the longitudinal head-bent sheet portion 14 and the longitudinal upright sheet portion 15 forms an insertion port for the longitudinal prong.

In the present application, the transverse head-bent sheet portion 12 and the bent upright sheet portion 13 are capable of being electrically connected to, through a surface contact, an inserted transverse prong, and the longitudinal head-bent sheet portion 14 and the longitudinal upright sheet portion 15 are capable of being electrically connected to, through a surface contact, an inserted longitudinal prong. Compared to the linear contact connection in the prior art, the surface contact connection not only has a larger contact area and higher electrical connection reliability, but also subjects the plug prong to relatively lower friction and pressure. This results in smoother insertion and removal, reduced wear, and consequently an extended service life. Furthermore, the bent upright sheet portion 13 includes a longitudinal upright segment 131 and a transverse upright segment 132, clearances 16 exist between the longitudinal upright segment 131 and the transverse head-bent sheet portion 12 and between the transverse upright segment 132 and the longitudinal upright sheet portion 15, a gap formed between the transverse upright segment 132 and the transverse head-bent sheet portion 12 forms an insertion port for the transverse prong, and a gap between the longitudinal head-bent sheet portion 14 and the longitudinal upright sheet portion 15 forms an insertion port for the longitudinal prong. Thus, the insertion port for the transverse prong and the insertion port for the longitudinal prong are spaced apart. As a result, the insertion and removal operations of the transverse prong and the longitudinal prong do not interfere with each other, and the insertion and removal of either prong will not alter the shape or dimensions of the insertion port for the other prong, thereby enhancing reliability.

As an optional implementation of embodiments of the present application, a surface of the transverse head-bent sheet portion 12, which is in proximity to the transverse upright segment 132, naturally includes a first curved surface 121, a transition plane 122, and a second curved surface 123 sequentially and continuously distributed from top to bottom. A curvature of the first curved surface 121 is greater than that of the second curved surface 123, and the transition plane 122 makes surface contact with an outer wall of the transverse prong after the transverse prong is inserted between the transverse head-bent sheet portion 12 and the bent upright sheet portion 13.

The configuration of the above curved surface 141 not only prevents stress concentration on a surface of the transverse head-bent sheet portion 12, that is used for electrical contact connection and reduces wear on the plug prong and the multi-purpose conductive piece 1, but also minimizes resistance during plug insertion and removal, thereby enhancing the user's operation experience.

As an optional implementation of embodiments of the present application, a surface of the longitudinal head-bent sheet portion 14, which is in proximity to the longitudinal upright sheet portion, naturally includes an upper curved surface 141, a connection plane 142, and a lower curved surface 143 sequentially and continuously distributed from top to bottom. A curvature of the upper curved surface 141 is greater than that of the lower curved surface 143, and the connection plane 142 makes surface contact with an outer wall of the longitudinal prong after the longitudinal prong is inserted between the longitudinal head-bent sheet portion 14 and the longitudinal upright sheet portion.

The configuration of the above curved surface 141 not only prevents stress concentration on a surface of the longitudinal head-bent sheet portion 14, that is used for electrical contact connection and reduces wear on the plug prong and the multi-purpose conductive piece 1, but also minimizes resistance during plug insertion and removal, thereby enhancing the user's operation experience.

As an optional implementation of embodiments of the present application, the transverse prong is a prong of a C20 plug that is compliant with national standards, and the longitudinal prong is a prong of a C14 plug that is compliant with national standards. This configuration enhances the versatility of the present application. Naturally, if the product is exported overseas, manufacturing can also comply with foreign standards.

As an optional implementation of embodiments of the present application, a stamped reinforcement rib 18 is provided on the transverse head-bent sheet portion 12 and the longitudinal head-bent sheet portion 14. The reinforcement rib 18 enhances the rigidity of the transverse head-bent sheet portion 12 and the longitudinal head-bent sheet portion 14, thereby ensuring durable elasticity.

As an optional implementation of embodiments of the present application, the base connection portion 11, the transverse head-bent sheet portion 12, the bent upright sheet portion 13, the longitudinal head-bent sheet portion 14, and the longitudinal upright sheet portion 15 are integrally formed as a one-piece structure.

This one-piece structure not only facilitates stamping but also ensures reliable connections between the respective components.

As an optional implementation of embodiments of the present application, the longitudinal upright segment 131 and the transverse upright segment 132 are integrally formed as a one-piece structure, and an angle between the two is a right angle.

As an optional implementation of embodiments of the present application, the base connection portion is configured to form the electrical connection with the conducting wire by plugging (configured as a prong configuration, for example, when the socket is used as an adapter socket), welding (configured as a welding prong or having a welding portion), wrapping, or using an intermediate conductor.

As an optional implementation of embodiments of the present application, the base connection portion may also be configured to form an electrical connection with a conductive busbar (plate) (e.g., a conductive copper busbar, as an equivalent alternative to the conductive wire).

A multi-purpose conductive piece provided by an embodiment of the present application includes a base connection portion and a transverse head-bent sheet portion, a bent upright sheet portion, a longitudinal head-bent sheet portion, and a longitudinal upright sheet portion fixedly connected to the base connection portion, wherein the base connection portion is configured to form an electrical connection with a conducting wire or a conductive busbar; the transverse head-bent sheet portion and the bent upright sheet portion are configured to be electrically connected to, through a surface contact, an inserted transverse prong; the bent upright sheet portion includes a transverse upright segment (the longitudinal upright segment is omitted in the structure), and a gap exists between the transverse upright segment and the longitudinal upright sheet portion, a gap formed between the transverse upright segment and the transverse head-bent sheet portion forms an insertion port for the transverse prong, the longitudinal head-bent sheet portion and the longitudinal upright sheet portion are configured to be electrically connected to, through a surface contact, the inserted longitudinal prong, and a gap between the longitudinal head-bent sheet portion and the longitudinal upright sheet portion forms an insertion port for the longitudinal prong.

The socket for use with a variety of plugs provided by the embodiments of the present application includes at least one socket unit, each of which is adapted to one of the plurality of plugs. The socket unit includes a housing 17 and at least two multi-purpose conductive pieces according to any one of the technical solutions of the present application disposed within the housing 17. Each socket unit contains three multi-purpose conductive pieces 1. The housing 17 is provided with insertion holes, each of which corresponds to one of the multi-purpose conductive pieces.

The socket for use with a variety of plugs provided by the present application may include one socket unit or two or more socket units. The plugs cooperating with the socket units on the same socket may be identical or different. The application of the multi-purpose conductive piece 1 provided by the present application offers the advantages of enhanced reliability and extended service life.

As an optional implementation of embodiments of the present application, the housing 17 includes an upper case 171 and a lower case 172. The insertion holes are provided in the upper case 171, which is selected from one of three types: a first type of upper case with T-shaped insertion holes, a second type of upper case with transverse line-shaped insertion holes, and a third type of upper case with longitudinal line-shaped insertion holes, each type of upper case capable of being adapted to the lower case 172 with the same structure.

The above configuration requires production of a single type of lower case 172, which can be combined with a variety of upper cases 171 to form a plurality of different sockets. These sockets can be designed for dual-purpose or single-purpose, thereby significantly improving production efficiency for sockets of different structures.

As an optional implementation of embodiments of the present application, an angle between an upper surface of the housing 17 and each of the longitudinal upright sheet portion 15, the longitudinal upright segment 131, and the transverse upright segment 132 is a right angle. The right-angle structure not only facilitates manufacturing but also ensures that the upright direction is parallel to the insertion direction of the plug prong, thereby making it easier to form surface contact electrical connections.

As an optional implementation of embodiments of the present application, the edge of the insertion holes of the upper case 171 is provided with a limiting flange. The size of an insertion hole for the plug prong formed by the limiting flange is smaller than that of the insertion hole for the transverse prong and the insertion holes for the longitudinal prong. Thus, the limiting flange serves both a limiting and guiding function, ensuring precise insertion direction of the prong and thereby more effectively enhancing the reliability of the present application.

As shown in FIG. 2, as an optional implementation of embodiments of the present application, the two multi-purpose conductive pieces are arranged symmetrically to each other, the bent upright sheet portions of the two symmetrically arranged multi-purpose conductive pieces are arranged in proximity to each other, and the longitudinal upright sheet portions of the two symmetrically arranged multi-purpose conductive pieces are arranged in proximity to each other.

The above are preferred embodiments of the present application and are not intended to limit the scope of protection of the present application. Therefore, any equivalent changes made based on the structure, shape, or principles of the present application shall be included within the scope of protection of the present application.

What is claimed is:

1. A multi-purpose conductive piece, comprising a base connection portion configured to form an electrical connection with a conducting wire and a transverse head-bent sheet portion, a bent upright sheet portion, a longitudinal head-bent sheet portion, and a longitudinal upright sheet portion fixedly connected to the base connection portion, wherein the transverse head-bent sheet portion and the bent upright sheet portion are capable of being electrically connected to, through a surface contact, an inserted transverse prong, the bent upright sheet portion comprises a longitudinal upright segment and a transverse upright segment, clearances exist between the longitudinal upright segment and the transverse head-bent sheet portion and between the transverse upright segment and the longitudinal upright sheet portion, a gap formed between the transverse upright segment and the transverse head-bent sheet portion forms an insertion port for the transverse prong, the longitudinal head-bent sheet portion and the longitudinal upright sheet portion are capable of being electrically connected to, through a surface contact, an inserted longitudinal prong, and a gap between the longitudinal head-bent sheet portion and the longitudinal upright sheet portion forms an insertion port for the longitudinal prong.

2. The multi-purpose conductive piece according to claim 1, wherein a surface of the transverse head-bent sheet portion, which is in proximity to the transverse upright segment naturally comprises a first curved surface, a transition plane, and a second curved surface sequentially and continuously distributed from top to bottom, wherein a curvature of the first curved surface is greater than that of the second curved surface, and the transition plane makes surface contact with an outer wall of the transverse prong after the transverse prong is inserted between the transverse head-bent sheet portion and the bent upright sheet portion.

3. The multi-purpose conductive piece according to claim 1, wherein a surface of the longitudinal head-bent sheet portion, which is in proximity to the longitudinal upright sheet portion naturally comprises an upper curved surface, a connection plane, and a lower curved surface sequentially and continuously distributed from top to bottom, wherein a curvature of the upper curved surface is greater than that of the lower curved surface, and the connection plane makes surface contact with an outer wall of the longitudinal prong after the longitudinal prong is inserted between the longitudinal head-bent sheet portion and the longitudinal upright sheet portion.

4. The multi-purpose conductive piece according to claim 1, wherein the transverse prong is a prong of a C20 plug that is compliant with national standards, and the longitudinal prong is a prong of a C14 plug that is compliant with national standards.

5. The multi-purpose conductive piece according to claim 1, wherein a stamped reinforcement rib is provided on the transverse head-bent sheet portion and the longitudinal head-bent sheet portion.

6. The multi-purpose conductive piece according to claim 1, wherein the base connection portion, the transverse head-bent sheet portion, the bent upright sheet portion, the longitudinal head-bent sheet portion, and the longitudinal upright sheet portion are integrally formed as a one-piece structure.

7. The multi-purpose conductive piece according to claim 1, wherein the longitudinal upright segment and the transverse upright segment are integrally formed as a one-piece structure, and an angle between the two is a right angle.

8. The multi-purpose conductive piece according to claim 1, wherein the base connection portion is configured to form the electrical connection with the conducting wire by plugging, welding, wrapping, or using an intermediate conductor.

9. The multi-purpose conductive piece according to claim 1, wherein the base connection portion is configured to form an electrical connection with a busbar.

10. A multi-purpose conductive piece, comprising a base connection portion and a transverse head-bent sheet portion, a bent upright sheet portion, a longitudinal head-bent sheet portion, and a longitudinal upright sheet portion fixedly connected to the base connection portion, wherein the base connection portion is configured to form an electrical connection with a conducting wire or a conductive busbar, the transverse head-bent sheet portion and the bent upright sheet portion are capable of being electrically connected to, through a surface contact, an inserted transverse prong, the bent upright sheet portion comprises a transverse upright segment, a clearance exists between the transverse upright segment and the longitudinal upright sheet portion, a gap formed between the transverse upright segment and the transverse head-bent sheet portion forms an insertion port for the transverse prong, the longitudinal head-bent sheet portion and the longitudinal upright sheet portion are capable of being electrically connected to, through a surface contact, the inserted longitudinal prong, and a gap between the longitudinal head-bent sheet portion and the longitudinal upright sheet portion forms an insertion port for the longitudinal prong.

11. A socket for use with a variety of plugs, comprising at least one socket unit, each of which is adapted to one of the plurality of plugs, wherein the socket unit comprises a housing and at least two multi-purpose conductive pieces according to claim 1 disposed within the housing, and the housing is provided with insertion holes, each of which corresponds to one of the multi-purpose conductive pieces.

12. The socket for use with a variety of plugs according to claim 11, wherein the housing comprises an upper case and a lower case, wherein the insertion holes are provided in the upper case, which is selected from one of three types: a first type of upper case with T-shaped insertion holes, a second type of upper case with transverse line-shaped insertion holes, and a third type of upper case with longitudinal line-shaped insertion holes, each type of upper case capable of being adapted to the lower case with a same structure.

13. The socket for use with a variety of plugs according to claim 11, wherein an angle between an upper surface of the housing and each of the longitudinal upright sheet portion, the longitudinal upright segment, and the transverse upright segment is a right angle.

14. The socket for use with a variety of plugs according to claim 11, wherein the two multi-purpose conductive pieces are arranged symmetrically to each other, the bent upright sheet portions of the two symmetrically arranged multi-purpose conductive pieces are arranged in proximity to each other, and the longitudinal upright sheet portions of the two symmetrically arranged multi-purpose conductive pieces are arranged in proximity to each other.
